(19) United States
(12) Patent Application Publication
(10) Pub. No.: US 2017/0270535 A1
(43) Pub. Date: Sep. 21, 2017

(54) Systems and Methods for Engineering and Publishing Compliant Content

(71) Applicant: LEADTRAIN, INC., Orem, UT (US)

(72) Inventors: Jordan McKee, Provo, UT (US); Kyle Hill, Orem, UT (US)

(21) Appl. No.: 15/308,826

(22) PCT Filed: Oct. 7, 2016
(86) PCT No.: PCT/US16/56151

§ 371 Date: Nov. 3, 2016

Related U.S. Application Data
(60) Provisional application No. 62/239,518, filed on Oct. 9, 2015.

(51) Int. Cl. G06Q 30/00; G06F 17/24; G06Q 50/26; G06F 17/27

(52) U.S. Cl. CPC G06Q 30/018; G06F 17/2785; G06F 17/248; G06Q 50/265; G06F 3/0482

(57) ABSTRACT

Systems and methods for engineering compliant communications are disclosed. In one embodiment, a computer system is provided that comprises processors and computer-readable storage media having stored thereon computer-executable instructions executable by the processors to cause the computer system to analyze a communication for compliance before publishing the communication. The computer-executable instructions include instructions that are executable to cause the computer system to perform at least the following: receive a communication, compare the communication against a set of predefined compliance standards, execute a compliance check to determine compliance with the predefined compliance standards, compile a compliance result of the compliance check, and prompt a user to review the compliance result before publishing the communication. Additional embodiments include computer executable instructions that cause the computer system to allow the user to modify the communication and/or to prohibit publication of the communication until it passes the compliance check.

### CROSS-REFERENCE TO RELATED APPLICATIONS

This application claims priority to U.S. provisional patent application 62/239,518 filed Oct. 9, 2015 entitled “Systems and Methods for Automated Email and Communication Management” which is incorporated herein by reference in its entirety.

### BACKGROUND OF THE INVENTION

Technical Field

The present disclosure relates generally to engineering and disseminating compliant content. More specifically, the present disclosure relates to parsing and modifying electronic media for compliant communications.

Background and Relevant Art

Home based publishing utilities have become useful for computer users. For example, some computer users may use home based publishing utilities to run a home business. In particular, users may use publishing utilities to create and publish content (e.g., general descriptive information, personal communications, motivational content, invitations, experiences, marketing materials, etc.) for goods and services. User content related to goods and services can be published, for example, to various social media platforms, through mobile and desktop applications, or to web sites. However, home based publishing utilities are often uninformed about certain government, industry, or enterprise regulations, which results in home based publishing utilities creating and publishing content that is not compliant with these regulations. This can expose the user—and others—to potential civil and/or criminal liability.

In some instances, civil and/or criminal liability may arise when non-compliant content has harmed a recipient or consumer of the user content. For example, a consumer may rely on misinformation propagated through user content to their own physical or pecuniary detriment. Modern publishing utilities lack contextual awareness for content being published and, therefore, cannot prevent the resultant pecuniary harms. Because publishing utilities are not equipped to recognize non-compliant content, this technology can be intentionally abused and/or negligently operated to publish non-compliant content in an effort to seek monetary gain. Regardless of the purpose for which the modern publishing utility is used, the end result is often the same—non-compliant content is published.

Outside of the civil and/or criminal liability associated with publishing non-complaint content, intangible assets of the home based user or an enterprise that represents or endorses the products or services proffered by the home based user are also threatened. For example, if a home based publishing utility is used to create content for goods or services of an enterprise—regardless of whether the enterprise endorses this use—and the content deceives a consumer base or tarnishes the reputation of the enterprise, the goodwill that has been established by the enterprise (and even the user) within that industry is likely to be harmed.

Due to the breadth, the frequency of changes, and, at times, the ambiguity of government, industry, and enterprise regulations, it is difficult, if not improbable, for a user of home based publishing utilities to know and adhere to all government, industry, and enterprise regulations when preparing and publishing content, and the current home based publishing utilities do not offer any relief.

Accordingly, there are a number of disadvantages in the art of engineering compliant content.

### SUMMARY OF INVENTION

### Technical Problem

There is a need for systems or methods that engineer and publish communications that are compliant with government, industry, and/or enterprise regulations, particularly for communications generated by home based users running a small business, though enterprise systems and methods for engineering and publishing compliant communications are similarly lacking. This need is particularly exacerbated when considering the dearth of compliance standards and regulations promulgated by government entities, industry organizations, and even enterprises, themselves, in addition to the rapidity by which these standards and regulations are amended, phased out, and/or newly implemented. Current systems and methods rely on physical surveillance of published content by trained and/or specialized individuals, but these individuals are incapable of monitoring and/or screening all published content. Additionally, compliance enforcement personnel are often unable to efficiently or properly implement current government, industry, or enterprise standards and regulations.

Further, compliance enforcement personnel often act at an enterprise or industry organization level to preemptively vet high-visibility and/or high-priority publishable content for compliance or to mitigate the collateral damage of non-compliant content in a post-publication capacity. Moreover, modern publishing utilities are ill equipped to make up for the deficiencies of the foregoing. In general, the implementations available for ensuring publication of compliant content suffer from a lack of compliance supported technology, user-induced error—whether by ignorance, applied misinformation, or other dysfunction—ambiguity of standards and regulations, and a complete lack of systems and methods that acquire and implement the myriad, even conflicting, standards and regulations to arrive at a compliant communication (or other content). Each of the foregoing may negatively impact home based publishing utilities and users of publishing utilities, consumers, enterprises, industry organizations, and/or government entities.

There is also a need for systems and methods that streamline task management and more efficiently process communications, data entries, notifications, and the like. The efficiency of a system is limited in some manner by time—whether it be the time is takes to process one or more pieces of data or the time required to build a system or product. Current systems are inefficient at processing communications, data entries, notifications, and the like, in part due to de novo processing or synthesis—a process that takes a significant amount of time. The efficiency of a system is also limited in some manner by the availability of resources—whether it be the instructions per second that can be performed on a CPU, the storage capacity of memory, the bandwidth of a communication channel, or the like. By reducing the amount of processing, data entry, and/or memory storage that are needed to perform a set of tasks, a system is able to streamline task management and more efficiently process communications, data entries, notifications, and the like.

Accordingly, systems and methods for engineering and publishing compliant communications and for increasing task management and processing efficiency are needed.

### Solution to Problem

Embodiments of the present invention comprise computer systems and computer-implemented methods for engineering and publishing compliant content, including user communications. In particular, this may comprise receiving a user communication and parsing said user communication. It may further comprise comparing the user communication against a set of predefined compliance standards and executing a compliance check to determine if the user communication is compliant with predefined compliance standards. It may further comprise compiling a compliance result of the compliance check, and prompting the user to review the compliance result before publication of the user communication.

Embodiments of the foregoing may additionally comprise allowing the user to modify the user communication following review of the compliance result. It may further comprise prohibiting publication of the user communication until the user communication passes the compliance check, wherein in some embodiments, the steps of executing a compliance check, prompting the user to review the compliance result, and allowing the user to modify the user communication are reiterated until the user communication passes the compliance check or is abandoned.

Embodiments of the present invention may be implemented in a computer assisted manner to analyze a communication for compliance. In some embodiments, the computer automatedly compares a user communication against a set of predefined compliance standards, executes a compliance check to determine if the user communication is compliant with the predefined compliance standards, compiles a compliance result of the compliance check, and prompts the user to review the compliance result before publication of the user communication. In some embodiments, a user interacts with a computer interface responsive to user selections to review the compliance result and modify the user communication sua sponte or, alternatively, in response to one or more computer recommended modifications. The modified user communication is again checked for compliance before publication. If the compliance check fails, the user is again presented with an opportunity to modify the user communication. If the compliance check is successful, the user is either prompted to approve publication or schedule publication of the user message, or, alternatively, the computer automatically publishes the compliant user communication. In one or more embodiments, the computer may automatedly modify a non-compliant user communication until the compliance check passes, at which time the computer publishes the modified user communication or prompts the user to review the modified user communication before publication.

Additional embodiments of the present disclosure comprise systems and computer-implemented methods for streamlining task management. In one embodiment, one or more tasks are automatically generated based on historical trends and/or a user input. The one or more automatically generated tasks are at least partially processed and stored at a time before the one or more automatically generated tasks are to be executed. In one or more embodiments, retrieving at least one partially processed task from storage and completing processing of the at least one partially processed task comprises a reduced processing time and/or a reduced resource demand than generating and processing the task on demand.

Embodiments of the foregoing may additionally comprise receiving at least a first and a second user entry and associating at least a first track of a plurality of tracks with the first user entry and a second track of the plurality of tracks with the second user entry, wherein each track of the plurality of tracks comprises a set of one or more predefined tasks. In one or more embodiments, the one or more automatically generated tasks comprise at least a subset of the set of one or more predefined tasks associated with the first and second tracks. In one or more embodiment, a user is prompted to review and/or modify a first task of the one or more automatically generated tasks.

Embodiments of the present disclosure provide a technical solution to the aforementioned technical problems associated with generating content that is compliant with government, industry, and/or enterprise regulations and with effectively monitoring communications at a government, industry, and/or enterprise level to determine and/or enforce compliance with one or more standards or regulations. Further, embodiments of the present disclosure provide a technical solution to the aforementioned technical problems associated with time and resource management, with streamlining task management, and with more efficiently processing communications, data entries, notifications, and the like.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF DRAWINGS

In order to describe the manner in which the above recited and other advantages and features of the disclosure can be obtained, a more particular description of the disclosure briefly described above will be rendered by reference to specific embodiments thereof, which are illustrated in the appended drawings. It is appreciated that these drawings depict only typical embodiments of the disclosure and are not therefore to be considered to be limiting of its scope.

In the drawings, multiple instances of an element may each include separate letters or numbers appended to the element number. For example, two instances of a particular element “100” may be labeled as “100A” and “100B” or similarly “100-1” and “100-2.” In each case, the element label may be used without an appended letter (e.g., “100”) to generally refer to every instance of the element, while the element label will include an appended letter or number (e.g., “100a” or “100-1”) to refer to a specific instance of the element. Similarly, a drawing number may include separate letters appended thereto. For example, FIG. 4 includes FIG. 4A, FIG. 4B, FIG. 4C, and FIG. 4D. In that case, the drawing number may be used without the appended letter (e.g., FIG. 4) to generally refer to every instance of the drawing, while the drawing label will include an appended letter (e.g., FIG. 4A) to refer to a specific instance of the drawing. The disclosure will be described and explained with additional specificity and detail through the use of the accompanying drawings in which:

FIG. 1 illustrates a schematic representation of a basic computing system according to one or more embodiments of the present disclosure;

FIG. 2 illustrates a schematic representation of a publishing system according to one or more embodiments of the present disclosure;

FIG. 3 illustrates a schematic representation of a graphical user interface for engineering compliant communications according to one or more embodiments of the present disclosure;

FIG. 4A illustrates a schematic representation of a graphical user interface for streamlining task management as provided on a desktop computing system according to one or more embodiments of the present disclosure;

FIG. 4B illustrates a schematic representation of a graphical user interface for streamlining task management as provided on a tablet according to one or more embodiments of the present disclosure;

FIG. 4C illustrates a schematic representation of a graphical user interface for streamlining task management as provided on a mobile device according to one or more embodiments of the present disclosure;

FIG. 4D illustrates a schematic representation of a graphical user interface for streamlining task management as provided on a mobile device according to one or more embodiments of the present disclosure;

FIG. 5 illustrates a computer-implemented method of streamlining task management according to one or more embodiments of the present disclosure;

FIG. 6 illustrates a user-implemented method of streamlining task management using one or more computer user interfaces according to one or more embodiments of the present disclosure;

FIG. 7 illustrates a computer-implemented method of engineering and publishing a compliant communication in accordance with one or more embodiments of the present disclosure; and

FIG. 8 illustrates a user-implemented method of engineering and publishing a compliant communication using one or more computer user interfaces in accordance with one or more embodiments of the present disclosure.

### DETAILED DESCRIPTION OF THE PREFERRED EMBODIMENTS

Before describing various embodiments of the present disclosure in detail, it is to be understood that this disclosure is not limited to the parameters of the particularly exemplified systems, methods, apparatus, products, kits, and/or processes, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments, and is not necessarily intended to limit the scope of the claimed invention.

Unless defined otherwise, all technical and scientific terms used herein have the same meaning as commonly understood by one of ordinary skill in the art to which the present disclosure pertains.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” “involves,” “contains,” etc.), and similar terms as used herein, including within the claims, shall be inclusive and/or open-ended, shall have the same meaning as the word “comprising” and variants thereof (e.g., “comprise” and “comprises”), and do not exclude additional un-recited elements or method steps, illustratively.

It will be noted that as used in this specification and the appended claims, the singular forms “a,” “an” and “the” include plural referents unless the context clearly dictates otherwise. Thus, for example, reference to a singular referent (e.g., “widget”) includes one, two, or more referents. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

To facilitate understanding, like reference numerals (i.e., like numbering of components and/or elements) have been used, where possible, to designate like elements common to the figures. Specifically, in the exemplary embodiments illustrated in the figures, like elements, or elements with like functions, will be provided with similar reference designations, where possible. Specific language will be used herein to describe the exemplary embodiments. Nevertheless, it will be understood that no limitation of the scope of the disclosure is thereby intended. Rather, it is to be understood that the language used to describe the exemplary embodiments is illustrative only and is not to be construed as limiting the scope of the disclosure (unless such language is expressly described herein as essential).

While the detailed description is separated into sections, the section headers and contents within each section are not intended to be self-contained descriptions and embodiments. Rather, the contents of each section within the detailed description are intended to be read and understood as a collective whole where elements of one section may pertain to and/or inform other sections. Accordingly, embodiments specifically disclosed within one section may also relate to and/or serve as additional and/or alternative embodiments in another section having the same and/or similar systems, modules, devices, methods, and/or terminology.

The embodiments disclosed herein will now be described by reference to some more detailed embodiments, with occasional reference to any applicable accompanying drawings. These embodiments may, however, be embodied in different forms and should not be construed as limited to the embodiments set forth herein. Rather, these embodiments are provided so that this disclosure will be thorough and complete, and will fully convey the scope of the embodiments to those skilled in the art.

### Computing Systems of the Present Invention

Computing systems are increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system—or combination thereof—that includes at least one physical and tangible processor and a physical and tangible memory capable of having thereon computer-executable instructions that may be executed by a processor. The memory may take any form and may depend on the nature and form of the computing system. A computing system may be distributed over a network environment and may include multiple constituent computing systems.

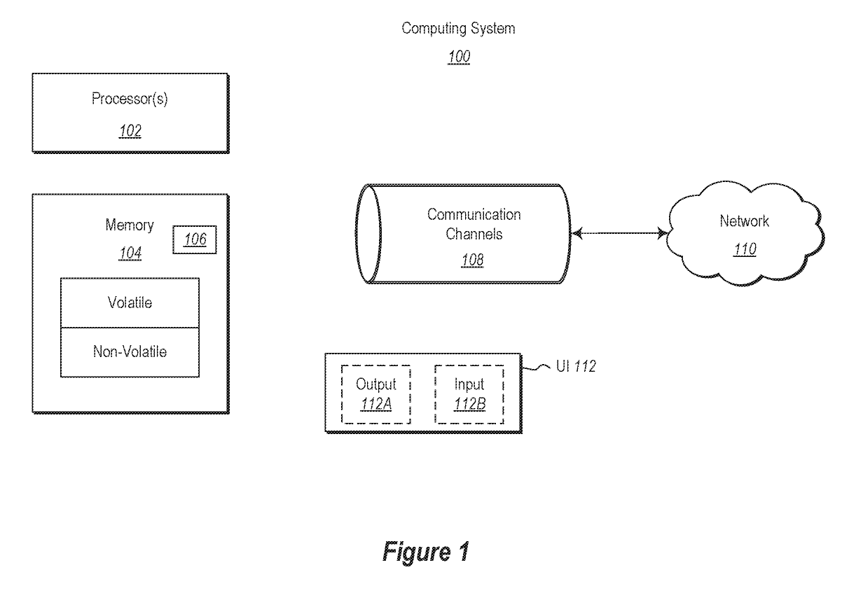

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory, and/or storage capability may be distributed as well.

The computing system 100 also has thereon multiple structures often referred to as an “executable component.” For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors—as is the case if the executable component were binary. Alternatively, the structure may be structured to be interpretable and/or compiled—whether in a single stage or in multiple stages—so as to generate such binary that is directly interpretable by the processors. Such an understanding of exemplary structures of an executable component is well within the understanding of one of ordinary skill in the art of computing when using the term “executable component.”

The term “executable component” is also well understood by one of ordinary skill as including structures that are implemented exclusively or near-exclusively in hardware, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit.

Accordingly, the term “executable component” is a term for a structure that is well understood by those of ordinary skill in the art of computing, whether implemented in software, hardware, or a combination. In this description, the terms “component,” “service,” “engine,” “module,” “control,” “generator,” or the like may also be used. As used in this description and in this case, these terms—whether expressed with or without a modifying clause—are also intended to be synonymous with the term “executable component,” and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse or other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation—embodiments of the invention can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium which can be used to store desired program code in the form of computer-executable instructions or data structures and which can be accessed and executed by a general purpose or special purpose computing system to implement the disclosed functionality of the invention.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Networks may be “private” or they may be “public,” or networks may share qualities of both private and public networks. A private network may be any network that has restricted access such that only the computer systems and/or modules and/or other electronic devices that are provided and/or permitted access to the private network may transport electronic data through the one or more data links that comprise the private network. A public network may, on the other hand, not restrict access and allow any computer systems and/or modules and/or other electronic devices capable of connecting to the network to use the one or more data links comprising the network to transport electronic data.

For example, a private network found within an organization, such as a private business, restricts transport of electronic data between only those computer systems and/or modules and/or other electronic devices within the organization. Conversely, the Internet is an example of a public network where access to the network is, generally, not restricted. Computer systems and/or modules and/or other electronic devices may often be connected simultaneously or serially to multiple networks, some of which may be private, some of which may be public, and some of which may be varying degrees of public and private. For example, a laptop computer may be permitted access to a closed network, such as a network for a private business that enables transport of electronic data between the computing systems of permitted business employees, and the same laptop computer may also access an open network, such as the Internet, at the same time or at a different time as it accesses the exemplary closed network.

Transmission media can include a network and/or data links which can be used to carry desired program code in the form of computer-executable instructions or data structures and which can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also—or even primarily—utilize transmission media.

Computer-executable instructions comprise, for example, instructions and data which, when executed at a processor, cause a general purpose computing system, special purpose computing system, or special purpose processing device to perform a certain function or group of functions. Alternatively, or additionally, the computer-executable instructions may configure the computing system to perform a certain function or group of functions. The computer executable instructions may be, for example, binaries or even instructions that undergo some translation (such as compilation) before direct execution by the processors, such as intermediate format instructions like assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, tablets, mobile telephones, PDAs, pagers, routers, switches, datacenters, wearables (e.g., glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### Compliance and Publishing Systems

Embodiments illustrated herein include a publishing system that allows users to create content and to publish the content to various external sources, such as web sites, electronic mail programs, text message applications, calendar tools, messaging and/or networking apps, social media platforms, and the like (referred to herein as “external sources”). Additionally, the publishing system includes a compliance enforcer that can evaluate the user's generated content to determine if the content complies with certain rules, regulations, and/or guidance (referred to herein as “compliance standards”) promulgated by various government entities, industry organizations or groups, enterprises, etc.

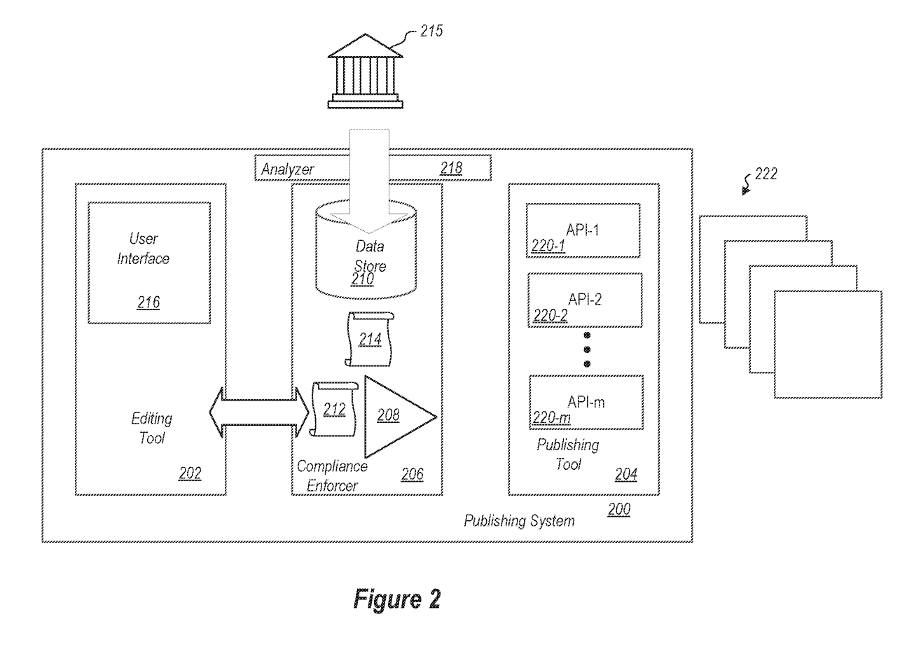

Referring now to FIG. 2 an exemplary publishing system 200 is illustrated. The publishing system 200 includes an editing tool 202, a publishing tool 204, and a compliance enforcer 206.

The publishing system 200 includes an editing tool 202. The editing tool 202 includes various graphical user interface elements 216 that allow a user to create and/or modify content. In particular, the editing tool 202 may include various text editor elements that allows a user to create free form text.

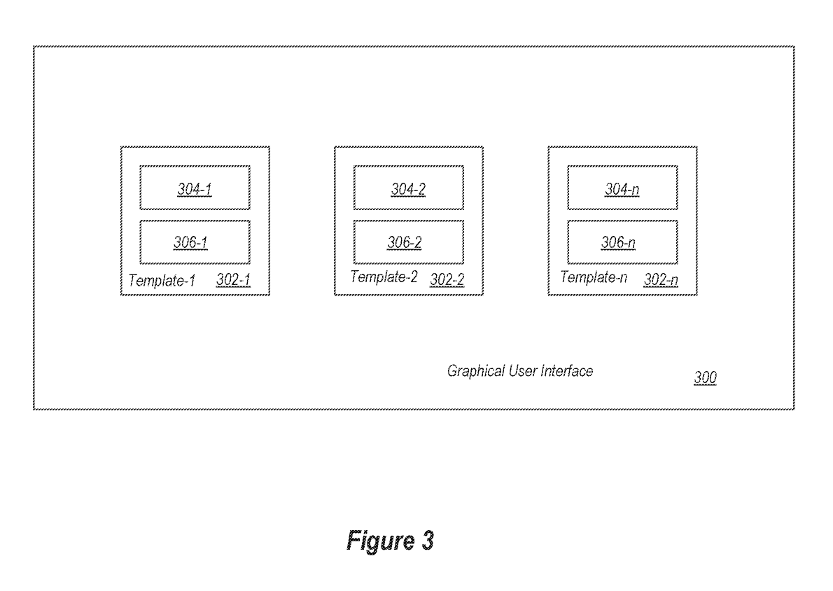

Additionally, or alternatively, the editing tool 202 may be configured to provide various templates to the user in a graphical user interface 216. The templates may be generic content containers that include certain generic content, but which also include user editable portions which a user can edit to customize content for publishing. For example, reference is made to FIG. 3 which illustrates a graphical user interface 300. The graphical user interface 300 is shown with a plurality of templates 302-1 through 302-n, and in some embodiments, template 302-n represents any individual template within the plurality of templates ranging from template 302-1 to template 302-n, where n is a positive integer. Each of the templates 302-1 through 302-n includes generic content 304-1 through 304-n and customizable content 306-1 through 306-n, respectively. The generic content 304 can be automatically scheduled to publish or immediately published without change, while the customizable content 306 allows a user to add custom information and/or more details.

Additionally, or alternatively, the customizable content 306 allows a user to modify media present in the customizable content. In some embodiments, the generic content 304 and/or the customizable content 306 comprises characters (e.g., Arabic numerals, Latin alphabet letters, Japanese kanji, Chinese Hanzi, Korean hanja, etc.), tuples (e.g., a finite ordered list of characters), symbols, words, phrases, graphics, images, audio, video, source code, object code, metadata, addresses, other information, or a combination of the foregoing that are incorporated into or are otherwise associated with customizable content 306. The templates 302 may be drawn from any number of sources known in the art, including, for example, a database populated and/or operated by a community (e.g., a wellness advocate community, a fitness community, a health food community, etc.), an enterprise (e.g., an enterprise that originates essential oils, supplements, exercise equipment, health foods, etc.), an industry organization, social network sites, or the like.

Using the editing tool 202, the user can create content (e.g., advertisements, messages, invitations, etc.) or other information for publishing on external sources, particularly social media web sites and/or platforms. Often, the user will create content directed to sales and/or marketing material for health products such as supplements, essential oils, exercise equipment, lifestyle advice, food extracts, etc. This content can later be published on various external sources, particularly social media websites, allowing the user to market various goods and services to others, and in particular to social media contacts. However, it is often important that descriptions of such goods and services not include certain words or phrases, or that such descriptions specifically include certain words or phrases, depending on, for example, the governmental jurisdiction, industry organization, and/or enterprise compliance standards relevant to the user and the goods or services upon which content is to be published. As a non-limiting example, the compliance standards may comprise one or more compliance policies promulgated by the United States Food and Drug Administration.

Returning once again to FIG. 2, the publishing system 200 includes a compliance enforcer 206. The compliance enforcer 206 is configured to receive, as input, user generated content from the editing tool 202. The compliance enforcer 206 can then determine if the content generated in the editing tool 202 is compliant with various compliance standards. These compliance standards may be provided by various user defined rules, government entities, industry groups, enterprises, etc. This can be accomplished in a number of different ways, which are discussed in more detail farther below.

With continuing reference to FIG. 2, the compliance enforcer 206 includes a comparator 208. The comparator 208 receives as input content 212 from the editing tool 202. The content 212 may include generic content in combination with user provided content. Alternatively, or additionally, some embodiments evaluate only the portion of the content 212 that comprises user provided content and/or customizable content. The comparator 208 additionally receives as input, compliance data 214 from a data store 210. For example, in some embodiments the compliance data 214 may be characters (e.g., Arabic numerals, Latin alphabet letters, Japanese kanji, Chinese Hanzi, Korean hanja, etc.), tuples (e.g., a finite ordered list of characters), symbols, words, phrases, graphics, images, audio, video, source code, object code, metadata, addresses, other information, or a combination of the foregoing (and which may be generally referred to herein as “compliance data”) that have been determined to be—or not be—in compliance with compliance standards of certain government entities, industry groups, and/or enterprises. In this way, the comparator can determine if certain compliance data is out of compliance with the compliance standards.

Note that while the example illustrated above illustrates determining that content 212 is out of compliance, some embodiments may use the functionality herein to affirmatively indicate that content 212 is in compliance by comparing compliance data known to be compliant with the content 212.

For example, in one or more embodiments, the comparator parses the input content to identify a pattern from the input content that logically matches one or more predefined patterns (e.g., one or more portions of the compliance standards or of the compliance data). Additionally, a logical match between a pattern from the input content and one or more predefined patterns may be based on a predefined threshold of similarity between the pattern and the predefined patterns. For example, a logical match may, in some embodiments, require an exact match, whereas in alternative embodiments, the threshold is at least 40% similar. In a preferred embodiment, the threshold is at least 60% similar. In a more preferred embodiment, the threshold is at least 75% similar. In a most preferred embodiment, the threshold is at least 90% similar. In one or more alternative embodiments, the threshold is not based on a percentage similarity but rather by a contextual similarity as determined by natural language processing algorithms coupled with machine learning networks trained on one or more known sets of compliant and non-compliant content and/or compliance data.

In one or more embodiments, parsed content generating a logical match, or stated in an analogous way, user communication compared against a set of predefined compliance standards, can be checked for compliance with predefined compliance standards. In one or more embodiments, this is accomplished by activating a rules engine that evaluates the logical match to determine whether the pattern is compliant with one or more predefined rules. This may comprise accessing one or more rules generated from the compliance standards, which inform the rules engine as to whether the logical match is non-compliant or compliant. As a simplified example, a rule may state that the content cannot contain a profanity, and if the logical match comprises a profanity, the rule engine identifies the content as non-compliant. As an additional example, a rule may state that essential oils cannot be referenced with the word “cure” and the word “cancer” or a context pertaining thereto, and if the logical match was the word “cure” in the context of essential oils and chemotherapy, the rule engine may identify the content as non-compliant. On the other hand, if the characters “cure” were a logical match in the content but were determined to be used in the context of essential oils and bacon—a type of cured meat—the rule engine may identify the content as compliant.

Referring back to FIG. 2, the compliance enforcer 206 can evaluate the results of a comparison at the comparator 208, and when words or phrases in the content 212 from the editing tool 202 are not in compliance with compliance standards represented by the compliance data 214, the compliance enforcer 106 can perform a number of different actions. For example, in some embodiments the compliance enforcer can flag noncompliant content in a user interface 216 to the user at the editing tool 202, which may include prompting the user to view the user interface 216. The compliance enforcer 206 may indicate to the user in the user interface 216 why the text is out of compliance (i.e., provide a compliance result). Additionally, or alternatively, the compliance enforcer 206 can indicate to the user in the user interface 216 of the editing tool 202 various actions that can be performed by the user to correct the text such that the text would then be in compliance with the rules, regulations, and/or guidance. This may include providing one or more suggested alterations, and in some embodiments, the suggested alterations comprise one or more recommended context-specific content that is known to be compliant or is deemed to be compliant by the computing system and/or one or more machine learning modules. In the context of a rules engine, the recommended context-specific compliant content may be based on the one or more predefined patterns or the one or more predefined rules.

In some embodiments, the compliance enforcer 206 can automatically correct content and/or delete content that is out of compliance. In some embodiments, the compliance enforcer 206 can prevent user generated content that includes content that is out of compliance with certain compliance standards from being provided to the publishing tool 204, essentially preventing non-compliant content from being published using the publishing system 200. In some embodiments, the non-compliant content is modified until it passes the compliance check, after which it may be published by the publishing tool 204.

The compliance data 214 in the database 210 may be generated in a number of different fashions, including and in addition to those illustrated above. For example, in some embodiments, the compliance data may simply be derived from a dictionary of manually entered compliance data known to be compliant and/or non-compliant.

In an alternative embodiment, the publishing system 200 may be able to obtain dictionaries of words and phrases (or other compliance data) that are known to be non-compliant and/or words and phrases (or other compliance data) that are known to be compliant with the compliance standards from various sources. For example, certain enterprises (e.g., corporations) may have a vested interest in ensuring that sales consultants, wellness advocates, and/or other representatives of the company do not disseminate information that is non-compliant with their own internal rules, regulations, and/or guidance. As such, a compliance enforcer 206, and in particular the data store 210, may include an interface that is capable of communicating with an enterprise system (e.g., a company computer system) such that the external enterprise system can provide updated compliance data for storage in the data store 210. Similar scenarios may be implemented where government entities, industry groups, or others can interface with the publishing system 200 to directly provide compliance data to the publishing system 200 which can be used by the compliance enforcer 206.

Delivery of such compliance data may be accomplished in a number of different ways. For example, the compliance enforcer 206 may include an interface that automatically queries the various sources described above. Alternatively, or additionally, the compliance enforcer 206 may subscribe to information from external enterprises, industry groups, or government entities such that these entities automatically, or upon request, provide compliance data by publishing the compliance data to subscribed entities, including, in this example, the compliance enforcer 206.

In yet another alternative or additional embodiment, the system may include an analyzer 218 that is configured to analyze various items and attempt to determine, such as by inference, deduction, or other analysis, the compliance data for the data store 210. For example, the analyzer 218 may obtain documents from a corpus 215 of publicly available, relevant data sources such as legal opinions, legal notices, administrative rulings, public letters issued by government entities, public letters issued by industry groups, public letters issued by companies, etc., and analyze the documents to attempt to identify compliance data from the documents. In particular, the analyzer 218 may be able to determine particular words and phrases mentioned in the documents, and determine whether the words or phrases and phrases are indicated to be compliant or non-compliant with any of the compliance standards.

In some embodiments, the analyzer 218 may include machine learning functionality that is capable of refining its analysis process over time to be able to more accurately identify words and phrases that are compliant and/or non-compliant. For example, the compliance data may be derived from data first accumulated and compiled by a crawler searching and retrieving information from the corpus 215 of publicly available, relevant data sources described above, which may additionally, or alternatively, comprise websites, forums, publications, and/or news reports, which is then parsed and/or analyzed by any of a combination of a natural language processor, an image, sound, and/or video processor, and one or more machine learning networks (e.g., neural networks or other machine learning models and networks known in the art) that are configured to identify and predict compliant content from non-compliant content, and which may from time to time update and refine its predictive capacity and/or accuracy.

Referring once again the FIG. 2, FIG. 2 illustrates the publishing tool 204. The publishing tool 204 can receive content generated from the editing tool 202 that has that has been determined by the compliance enforcer 206 to be compliant (or at least not non-compliant) with rules, regulations, and/or guidance. The publishing tool 204 can automatically publish such data to various external sources (as defined above). In particular, the publishing tool 204 may include a user's login information for a number of different websites such that once a user has generated content that is compliant (or not non-compliant) with the rules, regulations, and/or guidance, the content can be automatically published to a number of different websites. This allows the content to be distributed broadly with minimal user input. Note that the publishing tool 104 may store various user names and passwords for the various websites to which the user wishes to publish their content. Additionally, the publishing tool 204 may include various application programming interfaces (APIs) that are configured to interact with the various external sources 222.

Additionally, in one or more embodiments, the publishing tool, when publishing compliant content, may include an endorsement indicating that the published content has been analyzed and found to be compliant. The endorsement may be explicit and directly associated with the publication (e.g., as an image, character, or emblem on the published content), as a watermark, or associated with metadata of the published content.

### Graphical User Interfaces for Streamlining Task Management

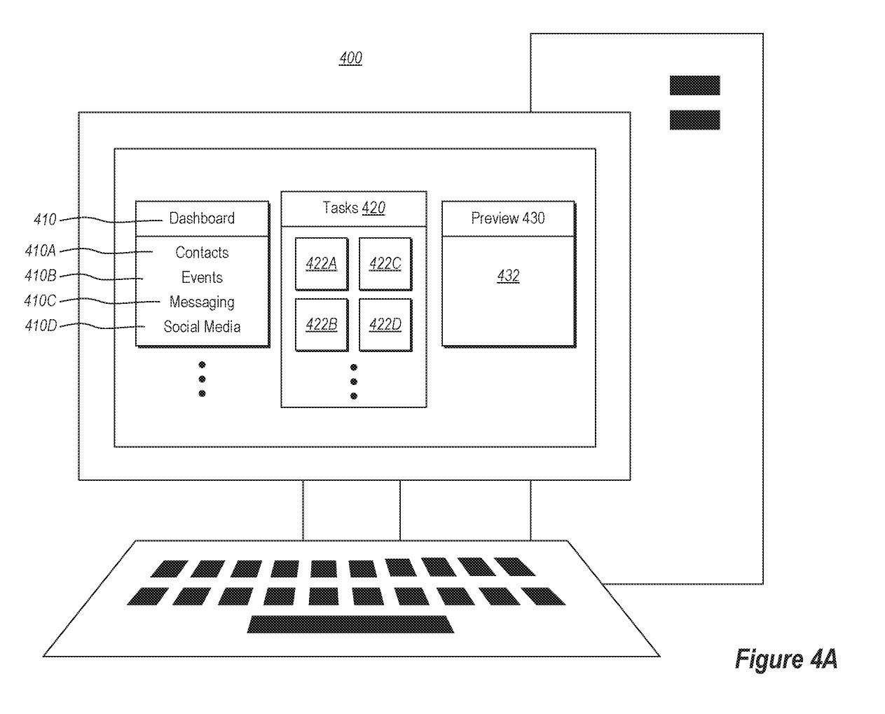

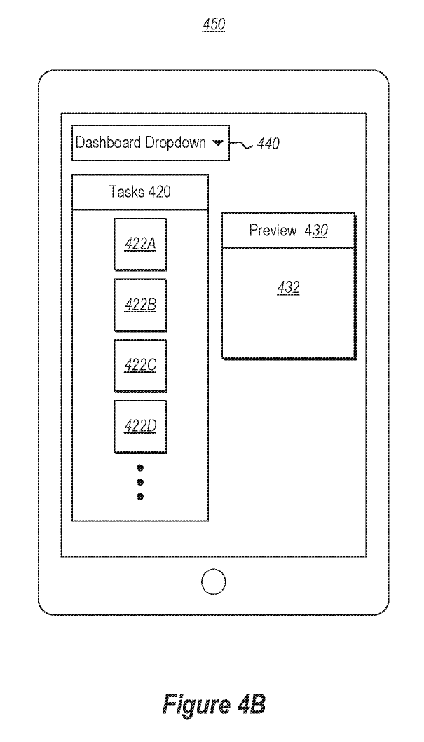

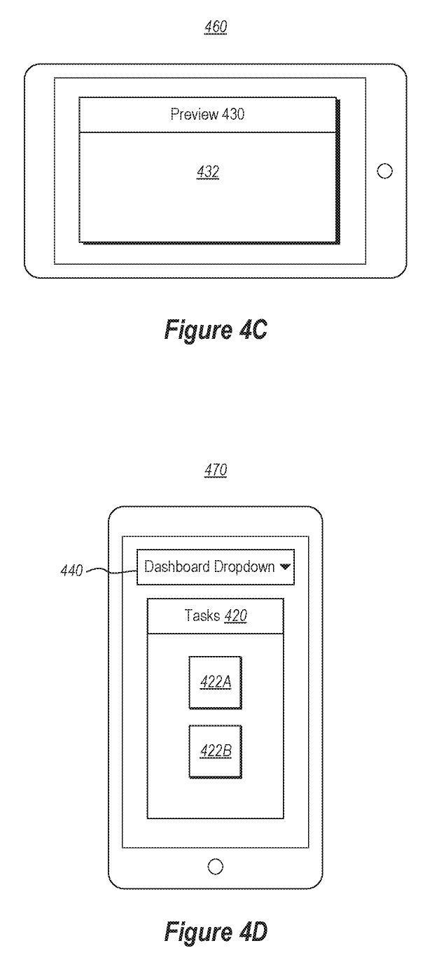

In one or more embodiments, the foregoing publishing tool is incorporated into a larger system, application (provided locally or through a network application such as a via SaaS), and/or as one module of many in a collection of executable components. Referring now to FIG. 4, illustrated are schematic representations of graphical user interfaces (which may interchangeably be referred to as simply user interfaces) for streamlining task management as provided on a desktop computing system (FIG. 4A), a tablet (FIG. 4B), and a mobile device (FIGS. 4C and 4D). Initially, the functionality of the user interface will be described with respect to a desktop computing system. It should be understood that the same and/or similar functionality is available on each of the other computing systems shown in FIG. 4, albeit through a modified user interface for each of the tablet and the mobile devices illustrated.

Referring now to FIG. 4A, illustrated is user interface 400, which can be accessed through locally executed instructions (e.g., software run on the desktop), through instructions run on one or more servers over a network (e.g., as SaaS accessed through the Internet), or by any other means known in the art. In one or more embodiments, the user interface 400 comprises dashboard 410, tasks board 420, and preview element 430.

The user interface 400 includes a dashboard 410. The dashboard 410 includes a plurality of selectable navigation points, including for example, contacts 410A, events 410B, messaging 410C, social media 410D. Additionally, or alternatively, the dashboard 410 comprises selectable navigation points such as account settings, an administrative panel, compliance, tracks, and logout. Each of the foregoing selectable navigation points in dashboard 410 are named according to their respective functionality, some of which will now be explicitly characterized. However, any selectable navigation point, whether specifically characterized or not, is considered to have any functionality known in the art that would be contextually relevant and that would be expected by one having ordinary skill in the art. For example, contacts 410A, when selected, allows a user to access information related to one or more contacts, like an address book. The foregoing example, at least, is exemplary of contextually relevant functionality known in the art.

Upon user selection of a selectable navigation point from the dashboard 410, one or more tasks 422 are populated in the tasks board 420. The one or more tasks 422 may be the same, may be different, or may be shared between one or more navigation points in dashboard 410. Task 422A, for example, may be selectable to create a new contextually relevant item such as, for example, creating a new contact when contacts 410A is selected, creating a new event when events 410B is selected, creating a new message when messaging 410C is selected, creating a new social media post when social media 410D is selected, and so on. In addition to sharing one or more tasks 422, one or more navigation points 410 may additionally interrelate. For example, messaging 410C may access one or more data points from contacts 410A, including, for example, a contact's name and telephone number, email address, and/or handle (e.g., screen name, alias, or other Internet-based identity). Many of the functions and cross-functional nature of navigation points and tasks behave as known in the art.

In an additional, or alternative, embodiment, the tasks 422 of task board 420 represent a type of to-do list, and for each selectable navigation point, the tasks 422 change (though some tasks may overlap) based on the tasks 422 associated with the selected navigation point. In one or more embodiments, when dashboard 410 selected, tasks board 420 acts as a notification center comprising pending, past due, and/or future tasks associated with or derived from any number of navigation points. Upon selecting, for example, social media 410D, the task board 420 will update to include only those tasks associated with social media. Examples of such tasks may include accepting friend requests, a reminder to wishing a social media contact a happy birthday, notifications of recent social media communications that may be of interest (as determined from adjustable user settings or as determined by one or more rules associated with the social media site), and similar. Of note in the foregoing example, if the social media contact whose is having a birthday is also in your contacts, selecting the contacts 410A navigation point may also populate the same or similar reminder to wish the contact a happy birthday. This is another illustration of the interconnected nature of the application displayed at user interface 400.

In one or more embodiments of the present disclosure, dashboard 410 comprises navigation points such as tracks, social media 410D, compliance, and/or administration panel. For example, a dashboard 410 comprising navigation point tracks, when selected, causes tasks board 420 to populate one or more tasks 422 associated with tracks functionality. Tracks, in one or more embodiments, comprises a plurality of tracks where each track individually comprises a set of predefined (or user defined) tasks. Additionally, one or more tracks may share one or more tasks. In one embodiment, one or more tracks can be assigned to each of a plurality of contacts and may be used to accomplish one or more goals or to streamline productivity. For example, a first contact may be assigned to a first track that is intended to develop and/or strengthen interpersonal relations with the first contact. The predefined set of tasks may include suggested actions, promptings to act, or a series of template messages that may be modified and sent to the first contact. For example, if the first contact is a new individual in the user's network, the first track may provide a series of template inquiries to the first contact that encourage interaction between the user and the first contact so that a stronger interpersonal connection may be formed.

In one or more embodiments, one or more tracks may be used in sales or marketing, where tasks include follow up communications for sales pitches, follow up communications to clients who recently purchased the user's goods or services, periodic check ups with former and/or current clients, etc. As described above, the tasks may be prepopulated and/or engineered with a template communication that allows the user to quickly and efficiently process more communications while expending less personal resources. In one embodiment, template responses to one or more tasks appear in preview 430, where they can be amended and/or edited to the user's satisfaction before published to the recipient.

In some embodiments, preview 430 shows a communication 432 in viewing area 432 that is publishing, is pending publication in the future, or has published in the past. In one or more embodiments, selecting a task 422 from the task board 420 related to a prepopulated and/or predefined communication may cause the prepopulated and/or predefined communication to appear as a communication 432 in preview element 430 where the user may edit the communication 432 and which the user may schedule for publication at a later time or immediately attempt to publish. Preview 430 may also display any other type of communication, including for example, emails and text messages (whether pending or published).

In one or more embodiments, before any communication or other user made content is cleared for publication, the user made content is check by a compliance module, which may be selected directly through the dashboard as a selectable navigation point or which may run in the background whenever a user attempts to publish user made content. The compliance module functions as previously described in FIGS. 2 and 3. Additionally, in one or more embodiments, dashboard 410 comprises selectable navigation point administration panel where an administrator of, for example, an enterprise, organization, or governmental entity may view compliance results for one or more users in the administrator's domain and/or jurisdiction. This may be embodied, for example, where a government entity is the administrator and enterprises are the users. In one embodiment, the compliance data representing the enterprise comprises a plurality of compiled and/or individually reported user data for employees and/or affiliates of the enterprise. As an exemplary embodiment, the administrator could be the United States Food and Drug Administration (or a designated representative thereof) and the users comprise enterprises in the supplement and/or essential oil industry whose compliance data comprises the compliance data from content published by a plurality of wellness advocates associated with the enterprise. In an alternative embodiment, the administrator is the enterprise and the employees and/or affiliates comprise the users, and it is the user's compliance data that the enterprise can monitor and/or report.

Referring now to FIG. 4B, illustrated is user interface 450 that comprises substantially the same functionality as user interface 400, but because of decreased screen size, some components previously visualized are temporarily off screen. For example, dashboard 440 is illustrated as a dropdown menu. Referring now to FIGS. 4C and 4D, illustrated are user interfaces 460 and 470 respectively. Of note, the user interfaces 460 and 470 are dynamic displays or are displaying dynamic content such that a first user interface 460 displays preview 430 when the mobile device is in a landscaped orientation and a second user interface 470 displays dashboard 440 and tasks 420 when the mobile device is in a portrait orientation. In one or more embodiments, all of the content and user functionality through the user interface 400 of FIG. 4A are available on each of the mobile devices depicted in FIGS. 4B-4D.

### Methods for Streamlining Task Management

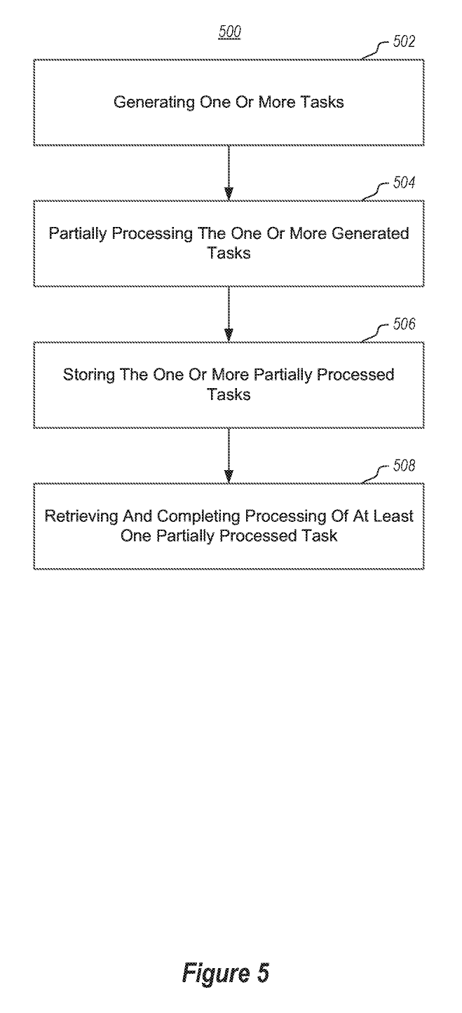

FIGS. 1-4 and the corresponding text illustrate or otherwise describe one or more systems, components, modules, mechanisms and/or graphical user interfaces related to engineering and publishing compliant content and streamlining task management. One will appreciate that embodiments of the present invention can also be described in terms of methods comprising one or more acts for accomplishing a particular result. For example, FIGS. 5-8, with the corresponding text, illustrates or otherwise describes a sequence of acts in methods for engineering and publishing compliant content and streamlining task management. The acts of FIGS. 5-8 are described below with reference to the components and modules illustrated in FIGS. 1-4, where appropriate.

FIG. 5 shows that a computer-implemented method 500 of streamlining task management can include an act 502 of generating one or more tasks. Act 502 can comprise generating one or more tasks based on historical trends or in response to a user input. For example, a user-monitoring module causes one or more tasks to be generated in response to one or more user inputs and/or behaviors. Additionally, or alternatively, the one or more tasks are generated in response to user request or are automatically generated based upon one or more predefined processes. In one embodiment, a processing module compiles and analyzes historical user data and automatically generates one or more tasks in anticipation of the user's actions.

FIG. 5 shows that the method 500 can also include act 504 of partially processing the one or more generated tasks. Act 504 can comprise processing, at least partially, the one or more generated tasks. In one embodiment, partially processing a task may comprise creating template content such as, for example, a template communication (e.g., a template email, a template text message, a template social media post having a generic content portion and a customizable content portion. Additionally, or alternatively, partially processing a task may comprise preauthorizing and/or pre-clearing a communication with a compliance module. Additionally, or alternatively, partially processing a task comprises compiling and/or processing at least a portion of computer executable instructions, wherein the partially compiled and/or partially processed portion of computer executable instructions a substantial part of the processed and/or compiled portion does not need to be reprocessed and/or recompiled at a later time.

FIG. 5 shows that the method 500 can also include act 506 of storing the one or more partially processed tasks. Act 506 can comprise storing the partially processed tasks, wherein the partially processed tasks are stored at a time before the partially processed tasks are to be executed by one or more processors of the computing system. FIG. 5 shows that the method 500 can also include act 508 of retrieving and completing processing of at least one partially processed task. Act 508 can comprise retrieving and completing processing of at least one partially processed task, wherein completing processing of the at least one partially processed task comprises a reduced processing time and/or a reduced resource demand than generating and processing the task on demand. In one embodiment, the stored partially processed tasks are stored in a state such that a substantial portion of the partially processed task does not need to be processed when removed from storage. For example, a partially processed task comprising the generation of template content may be stored as template content without the need of substantial reprocessing and/or without the need of substantial allocation of resources, wherein a substantial allocation of resources comprises a threshold allocation of resources. In one embodiment, the threshold allocation comprises more than 90% of the resources that would be used if processing the task on demand; in a preferred embodiment, more than 50% of the resources that would be used if processing the task on demand; and in a most preferred embodiment, more than 20% of the resources that would be used if processing the task on demand.

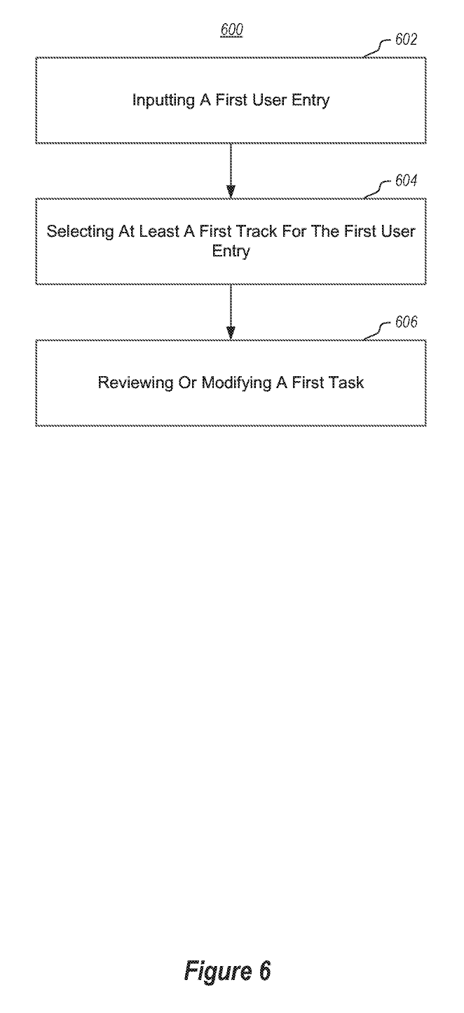

Referring now to FIG. 6, illustrated is a user-implemented method 600 of streamlining task management using one or more computer user interfaces. Method 600 can include an act 602 of receiving a first user entry. Act 602 can comprise receiving at a computer user interface a first user entry. For example, user interfaces 400, 450, 460, and/or 470 of FIG. 4 may be used for receiving a first user entry. Additionally, or alternatively, a first user entry is received at graphical user interface 216 of FIG. 2. FIG. 6 shows that the method 600 can also include act 604 of selecting at least a first track for the first user entry. Act 604 can comprise selecting at a computer user interface at least a first track of a plurality of tracks to be associated with the first user entry, wherein each track of the plurality of tracks comprises a set of one or more predefined tasks. In one embodiment, the predefined tasks comprise generating and/or processing one or more partially processed content. For example, partially processed content may comprise template content as described above. FIG. 6 shows that the method 600 can also include act 606 of reviewing or modifying a first task. Act 606 can comprise reviewing or modifying a first task of the set of one or more predefined tasks, wherein the first task comprises a task that has been partially completed by the computer system before the user views or modifies the first task. For example, a user may review or modify a first task in preview 430 of FIG. 4 and/or user interface 216 of FIG. 2. In some embodiments, the user modifies the first task based on one or more compliance reports relevant to at least a portion of the first task.

### Methods for Engineering and Publishing Compliant Communications

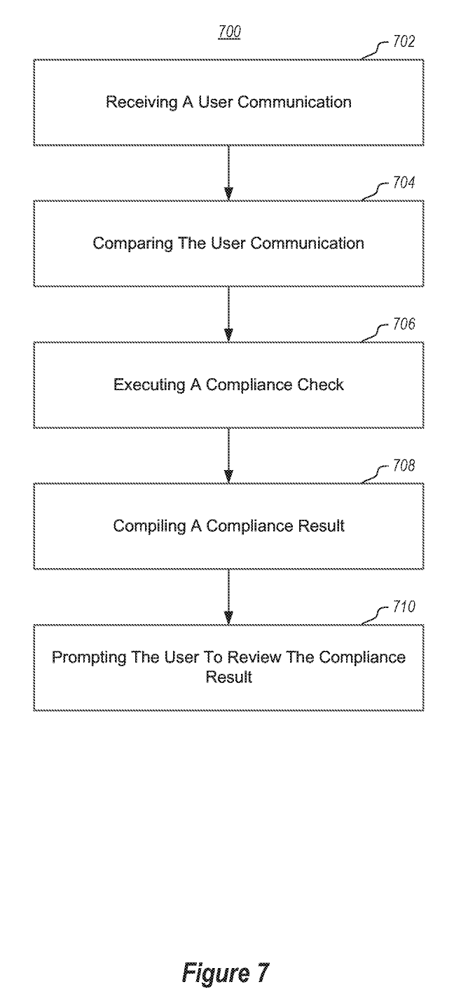

Referring now to FIG. 7, illustrated is a computer-implemented method 700 for engineering and publishing compliant content. Method 700 can include an act 702 of receiving a user communication. Act 702 can comprise receiving a user communication, wherein the user communication comprises a customizable content portion and a generic content portion. For example, compliance enforcer 206 of publishing system 200 of FIG. 2 may receive the user communication from editing tool 202. In some embodiments, the user communication may comprise a customizable content portion and a generic portion derived from template 302 of FIG. 3, and the customizable content portion of the user communication may comprise content modified by the user.

FIG. 7 shows that the method 700 can also include act 704 of comparing the user communication. Act 704 can comprise comparing the user communication against a set of predefined compliance standards. For example, comparator 208 of compliance enforcer 206 in FIG. 2 may compare the user communication 212 obtained from editing tool 202 against a set of predefined compliance standards stored in data store 210 and/or retrieved from a corpus 215 of publicly available, relevant data sources. In an alternative embodiment, the analyzer 218 of publishing system 200 in FIG. 2 acts to analyze the corpus 215 of publicly available, relevant data sources, and the analyzer 218 comprises one or more machine learning systems that may compare the user communication 212 received by the editing tool 202 against a set of predefined compliance standards derived during the machine learning process and which allow the analyzer 218 to determine and/or predict non-compliant content from compliant content form corpus 215.

FIG. 7 shows that the method 700 can also include act 706 of executing a compliance check. Act 706 can comprise executing a compliance check to determine if the user communication is compliant with the predefined compliance standards. For example, the comparator 208 or another module of compliance enforcer 206 may perform the compliance check based on the compliance data 214.

FIG. 7 shows that the method 700 can also include act 708 of compiling a compliance result. Act 708 can comprise compiling a compliance result of the compliance check. For example, the compliance enforcer 206 of FIG. 2 may comprise a compiler and/or processor to compile the compliance check. FIG. 7 shows that the method 700 can also include act 710 of prompting the user to review the compliance result. Act 710 can comprise prompting the user to review the compliance result before publication of the user communication. For example, the compliance enforcer 206 of FIG. 2 may send a compliance check to editing tool 202, which is displayed to the user through user interface 216. Additionally, or alternatively, the compliance result is displayed at preview 430 of FIG. 4, and in one or more embodiments, the user is prompted to view the compliance report by any method know in the art, including uses of visual and audible notifications at preview 430 or user interface 216 or through the computer systems illustrated in FIG. 4 or otherwise described herein that are operable to perform method 700.

Additionally, in one or more implementations, method 700 can also comprise an act of storing the compliance result in a data store and sending the compliance result to one or more enterprise systems or one or more governmental entities. For example, the compliance result may be stored in data store 210 of FIG. 2. Further, the compliance results may be sent to one or more enterprise systems or one or more governmental entities using publishing tool 204 of FIG. 2 using or independent from one or more APIs 220 of publishing tool 204. The publishing tool 204 is shown having a plurality of APIs 220-1 through 220-m, and in some embodiments, API 220-m represents any individual API within the plurality of APIs ranging from API 220-1 through API-m, where m is a positive integer, and where m may or may not be equal to n (defined above with respect to template 302-n).

Additionally, in one or more implementations, method 700 can also comprise an act of modifying the user communication by removing one or more portions of the user communication or replacing one or more portions of the user communication with context-specific compliant content. In one implementation, the context-specific compliant content is based on one or more predefined patterns or one or more predefined rules. Additionally, the one or more predefined patterns may comprise one or more portions of compliance data, and the one or more predefined rules may comprise at least a subset of the compliance standards. Additionally, or alternatively, the one or more predefined patterns are determined by a machine learning system that uses a corpus of publicly available, relevant data sources to define and update the one or more predefined patterns.

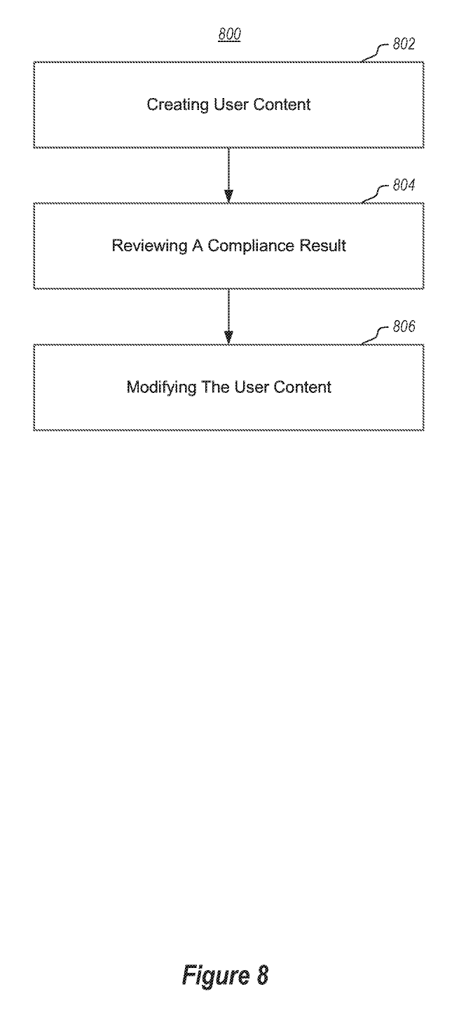

Referring now to FIG. 8, illustrated is a user-implemented method 800 for engineering and publishing compliant content using one or more computer user interfaces. Method 800 can include an act 802 of creating user content. Act 802 can comprise creating user content at one or more user interfaces. For example, a user, through editing tool 202 and user interface 216 of FIG. 2 may generate content de novo or may modify one or more templates 302 provided in graphical user interface 300, which in some embodiments is also user interface 216. Additionally, or alternatively, user content may be retrieved from data store 210 of compliance enforcer. In one embodiment the user content stored in data store 210 represents historical user content that may be reused.

FIG. 8 shows that the method 800 can also include act 804 of reviewing a compliance result. Act 804 can comprise reviewing a compliance result, wherein the compliance result comprises one or more compliant or one or more non-compliant portions of the user content. For example, a user can review compliance results at user interface 216 of FIG. 2 or through preview 430 of FIG. 4. In one embodiment, the user content is displayed at user interface 216 or preview 430, and the one or more compliant and/or the one or more non-compliant portions of the user content are highlighted or otherwise emphasized to the user.

FIG. 8 shows that the method 800 can also include act 806 of modifying the user content. Act 806 can comprise modifying the user content based on one or more recommendations. For example, the user may modify user content user interface 216. As an additional example, the user may modify the user content at graphical user interface 300 by choosing another of one or more templates 302 and editing, adding, and/or deleting customizable content from one or more templates 302. FIG. 8 shows that the method 800 can also include act 808 of publishing the user content. Act 808 can comprise publishing the user content to one or more external sources using a publishing tool. For example, the publishing tool 204 of publishing system 200 may publish the user content to various external sources 222 through or independent from APIs 220.

In one or more embodiments of the present disclosure, a computer system is provided for engineering compliant communications, the system comprising: one or more processors; and one or more computer-readable storage media having stored thereon computer-executable instructions that are executable by the one or more processors to cause the computer system to analyze a user input for compliance, the computer-executable instructions including instructions that are executable to cause the computer system to perform the following: receive a user input; parse the user input to identify a pattern from the user input that logically matches one or more predefined patterns, wherein a logical match between the pattern and the one or more predefined patterns is determined based on a predefined threshold; activate a rules engine, wherein the rules engine evaluates the logical match to determine whether the pattern is compliant with one or more predefined rules; compile a compliance result for the user input that comprises the pattern and a determination of whether the pattern is compliant; and prompt a user to review the compliance result.

In one or more embodiments, the foregoing computer system further includes computer executable instructions that when executed by the one or more processors cause the computer system to store the compliance result in a data store and/or to send the compliance result to one or more enterprise systems or one or more government entities. In one or more embodiments, the aforementioned computer system further includes computer executable instructions that when executed by the one or more processors cause the computer system to modify the user communication by removing one or more portions of the user communication or replacing the one or more portions of the user communication with one or more recommended context-specific compliant content, wherein the one or more recommended context-specific compliant content is based on the one or more predefined patterns or the one or more predefined rules. In one or more embodiments, the one or more predefined patterns are determined by a machine learning system that uses a corpus of publicly available, relevant data sources to define and update the one or more predefined patterns. In one or more embodiments, the one or more predefined rules comprise one or more compliance standards provided by a government entity. The government entity may be, for example, the FDA.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, devices, products, kits, methods, and/or processes, according to certain embodiments of the present disclosure may include, incorporate, or otherwise comprise properties, features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

1. A computer system for engineering compliant communications comprising:
one or more processors; and
one or more computer-readable storage media having stored thereon computer-executable instructions that are executable by the one or more processors to cause the computer system to analyze a communication for compliance before publishing said communication, the computer-executable instructions including instructions that are executable to cause the computer system to perform at least the following:
receive a user communication;
compare the user communication against a set of predefined compliance standards;
execute a compliance check to determine if the user communication is compliant with the predefined compliance standards;
compile a compliance result of the compliance check; and
prompt the user to review the compliance result before publication of the user communication.

2. The system as in claim 1, wherein the system further includes computer executable instructions that when executed by the one or more processors cause the computer system to allow the user to modify the user communication following review of the compliance result.

3. The system as in claim 2, wherein the system further includes computer executable instructions that when executed by the one or more processors cause the computer system to prohibit publication of the user communication until the user communication passes the compliance check.

4. The system as in claim 3, wherein the system further includes computer executable instructions that when executed by the one or more processors cause the computer system to endorse the user communication for publication upon passing the compliance check.

5. The system as in claim 1, wherein the system further includes computer executable instructions that when executed by the one or more processors cause the computer system to display the compliance result.

6. The system as in claim 5, wherein the system further includes computer executable instructions that when executed by the one or more processors cause the computer system to provide an interface for viewing and interacting with the user communication.

7. The system as in claim 6, wherein the system further includes computer executable instructions that when executed by the one or more processors cause the computer system to determine at least one portion of compliance data that is prevalent among a set of user communications and display at the interface the at least one compliance data and whether the at least one compliance data is compliant.

8. The system as in claim 1, wherein the system further includes computer executable instructions that when executed by the one or more processors cause the computer system to provide a suggested alteration to the user communication.

9. The system as in claim 1, wherein the user communication references essential oils.

10. The system as in claim 9, wherein the user communication is destined for social media.

11. The system as in claim 9, wherein the user communication is destined for a press release.

12. The system as in claim 1, wherein the set of predefined compliance standards comprise one or more standards provided by a government entity.

13. The system as in claim 12, wherein the set of predefined compliance standards comprise one or more compliance policies promulgated by the United States Food and Drug Administration.

14. The system as in claim 1, wherein the set of predefined compliance standards are established by an enterprise organization.

15. A method, implemented at a computer system that includes one or more processors, for engineering a compliant communication for publishing, the method comprising:
receiving a user communication;
comparing the user communication against a set of predefined compliance standards;
executing a compliance check to determine if the user communication is compliant with the predefined compliance standards;
compiling a compliance result of the compliance check;
modifying the user communication by removing one or more portions of the user communication or replacing one or more portions of the user communication with context-specific compliant content; and
prompting the user to review the compliance result before publication of the user communication.

16. A computer system for engineering compliant electronic media comprising:
one or more processors; and
one or
that when executed by the one or more processors cause the computer system more computer-readable storage media having stored thereon computer-executable instructions that are executable by the one or more processors to cause the computer system to analyze a user input for compliance, the computer-executable instructions including instructions that are executable to cause the computer system to perform at least the following:
receive a user input;
parse the user input to identify a pattern from the user input that logically matches one or more predefined patterns, wherein a logical match between the pattern and the one or more predefined patterns is determined based on a predefined threshold;
activate a rules engine, wherein the rules engine evaluates the logical match to determine whether the pattern is compliant with one or more predefined rules;
compile a compliance result for the user input that comprises the pattern and a determination of whether the pattern is compliant; and
prompt a user to review the compliance result.

17. The system as in claim 16, wherein the system further includes computer executable instructions to store the compliance result in a data store and send the compliance result to one or more enterprise systems or one or more government entities.

18. The system as in claim 16, wherein the system further includes computer executable instructions that when executed by the one or more processors cause the computer system to modify the user communication by removing one or more portions of the user communication or replacing the one or more portions of the user communication with one or more recommended context-specific compliant content, wherein the one or more recommended context-specific compliant content is based on the one or more predefined patterns or the one or more predefined rules.

19. The system as in claim 16, wherein the one or more predefined patterns are determined by a machine learning system that uses a corpus of publicly available, relevant data sources to define and update the one or more predefined patterns.

20. The system as in claim 16, wherein the one or more predefined rules comprise one or more compliance standards provided by a government entity.
